(19) United States
(12) Patent Application Publication
(10) Pub. No.: US 2024/0403509 A1
(43) Pub. Date: Dec. 5, 2024

(54) PRODUCT SHAPE DESIGN METHOD USING CONTACT BODY PRESSURE ANALYSIS AND DEVICE THEREFOR

(71) Applicants: HANDONG GLOBAL UNIVERSITY INDUSTRY-ACADEMIC COOPERATION FOUNDATION, Pohang-si (KR); POSTECH RESEARCH AND BUSINESS DEVELOPMENT FOUNDATION, Pohang-si (KR); UNIVERSITY-INDUSTRY COOPERATION GROUP OF KYUNG HEE UNIVERSITY, Yongin-si (KR)

(72) Inventors: Wonsup LEE, Pohang-si (KR); Jingyun KIM, Suwon-si (KR); Heecheon YOU, Pohang-si (KR); Yunjae KWON, Seoul (KR)

(21) Appl. No.: 18/701,075

(22) PCT Filed: Oct. 13, 2021
(86) PCT No.: PCT/KR2021/014088

§ 371 Date: Apr. 12, 2024

(51) Int. Cl. G06F 30/17; A41D 13/11; G06F 30/23; G06F 111/16

(52) U.S. Cl. CPC G06F 30/17; A41D 13/11; G06F 30/23; G06F 2111/16

(57) ABSTRACT

Disclosed are a product shape design method using contact body pressure analysis and a device therefor. The product shape design method according to an embodiment of the present invention includes the steps of: receiving body scan data of a subject; generating a virtual subject corresponding to the subject on the basis of the received body scan data; contacting the generated virtual subject with a preconfigured product shape to be designed and calculating contact pressure generated by contact of the virtual subject and the product shape; and designing the product shape by changing the product shape on the basis of the calculated contact pressure.

### TECHNICAL FIELD

The present disclosure relates to a product shape design technology using contact body pressure analysis and more specifically, a product shape design method and device capable of designing a product shape that provides appropriate pressure to the human body through contact pressure analysis using finite element analysis.

### BACKGROUND ART

Three-dimensional (3D) human body scanning and analysis technology has emerged over the past decade and has been usefully applied to ergonomic product design, orthopedics, plastic surgery, medicine, fashion, film production, and gaming. A 3D scan image of a human may provide a variety of useful information for product design, including anthropometric body dimensions (e.g., length, width, length between circumference and any other point, or surface length) and body geometry information (e.g., arcs, section curvature, surfaces, area, and volume). In particular, face-wearable products such as masks and goggles need to have an ergonomically designed shape to fit a target user's face well.

An optimal shape (or geometry) for facial product design may be found by analyzing facial anthropometry, shape characteristics, and contact pressure between the product and the face. For example, the prior art has proposed a computer-based analysis of the fit between a face and a mask to find the best shape for the mask. The prior art is achieved by virtually wearing an appropriate mask design on each 3D face image, calculating the distance and contact pressure between the mask and the face, and repeating the mask design until the contact pressure is suitable for multiple people's faces.

### DETAILED DESCRIPTION OF THE INVENTION

### Technical Problem

Embodiments of the present disclosure are directed to a product shape designing method for designing a product shape that provides appropriate pressure to a human body through contact pressure analysis using finite element analysis and and a device therefor.

### Technical Solution

According to an embodiment of the present disclosure, a product shape design method includes receiving body scan data of a subject, generating a virtual subject corresponding to the subject on the basis of the received body scan data, contacting the generated virtual subject with a preconfigured product shape to be designed and calculating contact pressure generated by contact of the virtual subject and the product shape, and designing the product shape by changing the product shape on the basis of the calculated contact pressure.

The calculating of the contact pressure may include calculating a pressure of contact where the virtual subject is in contact with and the product shape using finite element analysis.

The receiving of the body scan data may include receiving a scanned three-dimensional mesh image for the subject.

The generating of the virtual subject may include generating the virtual subject based on mesh structure consistency between a pre-registered template mesh model and a scanned three-dimensional mesh image of the subject.

The designing of the product shape may include recalculating the contact pressure between the designed product shape and the virtual subject, determining the designed product shape as a final product shape when the recalculated contact pressure is within a preset reference pressure range, and changing the designed product shape based on the recalculated contact pressure when the recalculated contact pressure is outside the preset reference pressure range.

The designing of the product shape may include designing the product shape by changing an area where the calculated contact pressure is outside a preset reference pressure range among areas of the product shape based on the contact pressure of the area where the calculated contact pressure is outside the preset reference pressure range.

The calculating of the contact pressure may include calculating a contact pressure based on a change in each mesh of the virtual subject due to contact between the product shape and the virtual subject and a displacement vector of vertices of the each mesh.

According to an embodiment of the present disclosure, a product shape design device includes a receiving part that receives body scan data of a subject, a generating part that generates a virtual subject corresponding to the subject based on the received human body scan data, a calculating part that contacts the generated virtual subject with a preconfigured product shape to be designed and calculate contact pressure generated by contact of the virtual subject and the product shape, and a designing part that designs the product shape by changing the product shape on the basis of the calculated contact pressure.

The calculating part may calculate a pressure of contact where the virtual subject is in contact with and the product shape using finite element analysis.

The receiving part may receive a scanned three-dimensional mesh image for the subject.

The generating part may generate the virtual subject based on mesh structure consistency between a pre-registered template mesh model and a scanned three-dimensional mesh image of the subject.

The designing part may recalculate the contact pressure between the designed product shape and the virtual subject, determine the designed product shape as a final product shape when the recalculated contact pressure is within a preset reference pressure range, and change the designed product shape based on the recalculated contact pressure when the recalculated contact pressure is outside the preset reference pressure range.

The designing part may design the product shape by changing an area where the calculated contact pressure is outside a preset reference pressure range among areas of the product shape based on the contact pressure of the area where the calculated contact pressure is outside the preset reference pressure range.

The calculating part may calculate a contact pressure based on a change in each mesh of the virtual subject due to contact between the product shape and the virtual subject and a displacement vector of vertices of the each mesh.

### Advantageous Effects of the Invention

According to the embodiments of the present disclosure, it is possible to design a product shape that provides appropriate pressure to a human body through contact pressure analysis using finite element analysis.

The present disclosure may be applied to various products to be worn on various parts of a human body, such as, masks (oxygen masks, medical masks, custom masks for athletes, etc.), helmets, goggles, VR headsets, shoes, gloves, knee pads, products such as ankle pads and lumbar protectors, or the like.

### DESCRIPTION OF THE DRAWINGS

FIG. 1 is a flowchart of a method for designing a product shape according to one embodiment of the present disclosure.

FIG. 2 shows an example diagram for describing a process of generating a virtual subject.

FIGS. 3A and 3B show an example diagram for describing a process of calculating contact pressure in a mesh.

FIG. 4 shows an example of a mask.

FIG. 5 shows an example of contact pressure on a virtual subject.

FIG. 6 shows an example diagram for describing a process of designing a mask according to contact pressure.

FIG. 7 shows a configuration for a product shape design device according to one embodiment of the present disclosure.

### BEST MODE

Advantages and features of the inventive concept and methods for achieving them will be apparent with reference to embodiments described below in detail in conjunction with the accompanying drawings. However, the inventive concept is not limited to the embodiments disclosed below, but can be implemented in various forms, and these embodiments are to make the disclosure of the inventive concept complete, and are provided so that this disclosure will be thorough and complete and will fully convey the scope of the invention to those of ordinary skill in the art, which is to be defined only by the scope of the claims.

The terminology used herein is for the purpose of describing particular embodiments only and is not intended to be limiting of the inventive concept. The singular expressions include plural expressions unless the context clearly dictates otherwise. In this specification, the terms “comprises” and/or “comprising” are intended to specify the presence of stated features, integers, steps, operations, elements, parts or combinations thereof, but do not preclude the presence or addition of steps, operations, elements, parts, or combinations thereof.

Unless defined otherwise, all terms (including technical and scientific terms) used herein have the same meanings as commonly understood by one of ordinary skill in the art to which this invention belongs. Further, unless explicitly defined to the contrary, the terms defined in a generally-used dictionary are not ideally or excessively interpreted.

Hereinafter, preferred embodiments of the inventive concept will be described in detail with reference to the accompanying drawings. The same reference numerals are used for the same components in the drawings, and duplicate descriptions of the same components are omitted.

Embodiments of the present disclosure are directed to designing a product shape that provides appropriate pressure to a human body through contact pressure analysis using finite element analysis.

The present disclosure may generate a virtual subject corresponding to a subject based on a mesh structure consistency between the three-dimensional human body scan data of the subject and a pre-registered or preset three-dimensional template model, calculate a contact pressure between the generated virtual subject and a product shape to be designed, and then change the shape of some regions of the product shape based on the calculated contact pressure, allowing the contact pressure in contact with the human body to be evenly distributed.

Further, the present disclosure may recalculate the contact pressure between the changed product shape and the virtual target after changing the product shape, determine the changed product shape as a final product shape when the recalculated contact pressure is within a preset reference pressure range, and repeatedly perform a process of again changing the changed product shape again based on the recalculated contact pressure when the recalculated contact pressure is outside the reference pressure range, that is, when the contact pressure in some regions is outside the reference pressure range. In other words, by repeatedly performing the process of calculating the contact pressure, changing the product shape, and recalculating the contact pressure, the present disclosure may design the shape of a product to be worn on a human body, such as, oxygen masks, VR headsets, medical prosthetics and orthotics (e.g., neck braces, posture correctors, prosthetic hands, prosthetic legs, etc.), various protective devices (e.g., helmets, lumbar braces, elbow braces, knee braces, ankle braces, etc.)

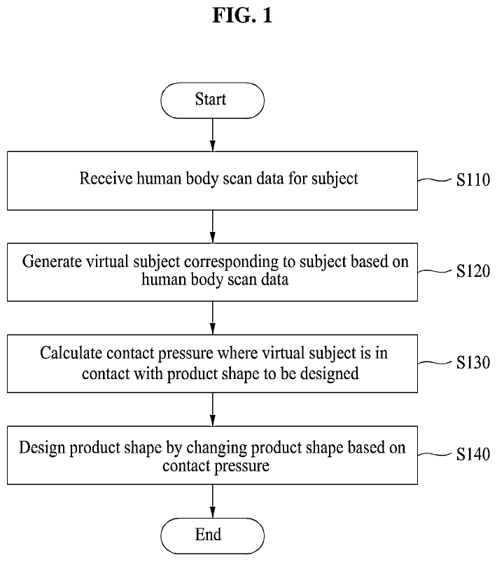

The present disclosure will now be described with reference to FIGS. 1 through 7.

FIG. 1 is a flowchart of a product shape design method according to one embodiment of the present disclosure.

Referring to FIG. 1, a product shape design method according to one embodiment of the present disclosure may include receiving human body scan data for a subject, e.g., a face, and generating a virtual subject corresponding to the subject based on the received human body scan data (S110, S120).

Here, step S110 may be a step of receiving a scanned three-dimensional mesh image for the subject, or receiving a general three-dimensional scan image without mesh, and step S120 may be a step of generating the virtual subject corresponding to the subject based on a mesh structure consistency between a pre-registered template mesh model and a scanned three-dimensional mesh image of the subject. The three-dimensional scan data received in step S110 may be data for a single person, or may be data for multiple persons.

According to the present disclosure, the mesh shape of the template model may have a difference in number of meshes and mesh size between a region in contact with the product and a region not in contact with the product, and it may be preferable that the mesh size of the region in contact is smaller than the mesh size of the region not in contact and the number of meshes in the region in contact is larger than the number of meshes in the area not in contact. In this case, the mesh shape of the template model may have a mesh structure such as a triangle, square, pentagon, hexagon, or the like, and may be unevenly distributed in different sizes in the face area. The present disclosure is described by taking a triangular mesh structure as an example.

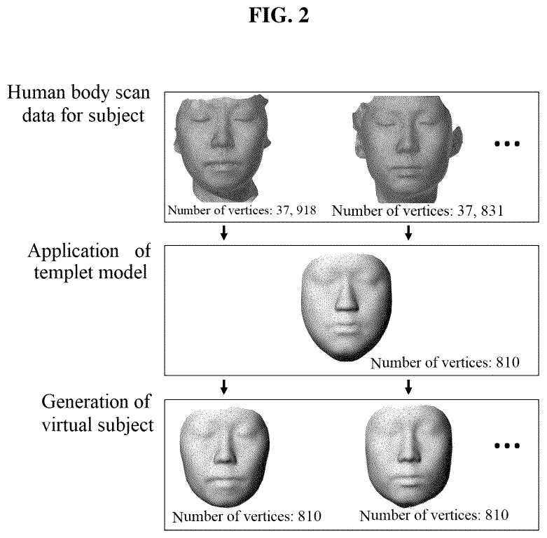

For example, step S120 may be a step of generating a three-dimensional virtual subject mesh image (template-registered image), which is a subject mesh image for each of the plurality of subjects, by registering the template model to three-dimensional human body scan data or a three-dimensional human body scan image using a pre-registered or pre-set template mesh model, as shown in FIG. 2. The present disclosure may generate a virtual subject mesh image by registering a template model for a single face, or generate virtual subject mesh images for faces by registering a template model for various types of faces.

After the virtual subject is generated by step S120, the generated virtual subject and a preconfigured product shape to be designed, such as a mask, are contacted, and the contact pressure of the region where the virtual subject and the product shape are contacted is calculated (S130).

In this case, step S130 may be a step of calculating a pressure of contact where the virtual object and the product shape are in contact with each other using finite element analysis and the contact pressure may be calculated based on a change in each of meshes of the virtual object due to the contact between the product shape and the virtual object and the displacement vector of the vertices of each of the meshes. The product shape used to calculate the contact pressure may include only the shape for a portion in contact with the virtual target, or may include the entire shape of the product.

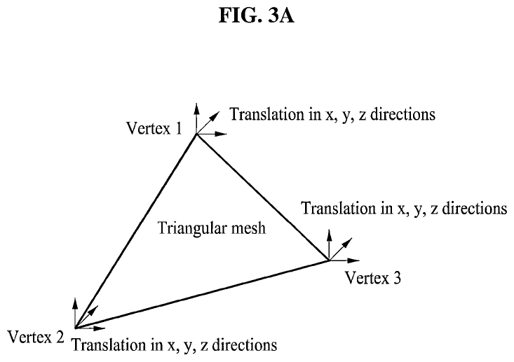

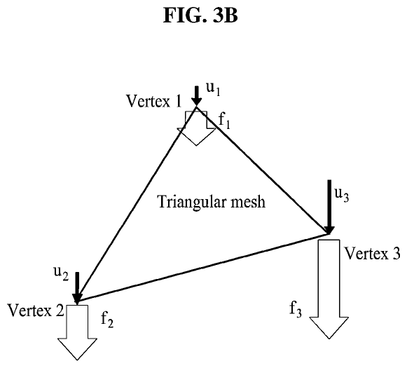

In step S130, for example, in the case of a triangular mesh, as shown in FIG. 3A, each triangular mesh of the virtual object has three vertices, and each vertex has six degrees of freedom (DOFs), i.e., deformations in the x, y, and z directions, so that the variation of one mesh may be represented by an 18×18 matrix, which may be a stiffness matrix.

The force at each vertex may then be calculated by <Equation 1> below.

$$f = K \times U \qquad [ Equation 1 ]$$

$$[ \begin{matrix}{f}_{1} \\ {f}_{2} \\ {f}_{3} \\ ⋮\end{matrix} ] = [ \begin{matrix}{k}_{11} & {k}_{12} & … \\ {k}_{21} & {k}_{22} & … \\ {k}_{31} & {k}_{32} & … \\ ⋮ & ⋮ & ⋱\end{matrix} ] [ \begin{matrix}{U}_{1} \\ {U}_{2} \\ {U}_{3} \\ ⋮\end{matrix} ]$$

Where f denotes a force at each vertex of a mesh, K denotes a stiffness matrix corresponding to a change in the mesh, and u denotes a displacement vector at each vertex. Here, the stiffness matrix may be a 9×9 stiffness matrix if each vertex has three degrees of freedom (DOFs). K may vary by a virtual object, e.g., a face, and may be an assembled stiffness matrix.

Displacement may refer to the amount of moved force (f1, f2, f3) at vertices generated by wearing the product, e.g., mask, on the face, as shown in FIG. 3B, and the contact pressure may mean the force divided by the area.

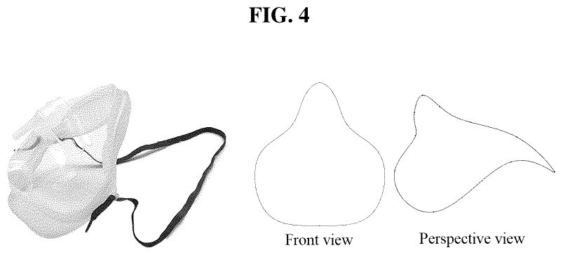

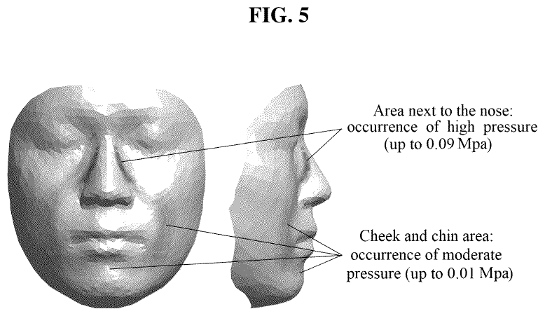

For example, as shown in FIG. 4, if there is a product shape (front view, perspective view) for a mask, and a product of such a shape contacts a virtual subject, i.e., a virtual mesh face, the contact pressure caused by the contact on the virtual face may be calculated. In this case, the contact pressure calculated at each vertex of the virtual face may be calculated, and the contact pressure calculated at each vertex may be represented, such as in the example shown in FIG. 5. As shown in FIG. 5, when a mask having the shape of FIG. 4 is worn on the corresponding virtual face, it can be seen that the contact pressure is high in the areas next to the nose, the contact pressure is low in the area of the chin, and the contact pressure in the remaining areas is within a preset reference pressure range.

Referring again to FIG. 2, once the contact pressure at each vertex is calculated by step S130, a product shape is designed to fit the virtual subject by changing the product shape based on the calculated contact pressure (S140).

For example, as shown in FIG. 5, once the contact pressure is calculated, in step S140, the product shape may be designed by changing the product shape in the areas next to the nose in a direction to decrease the contact pressure, and changing the product shape in the area of the chin in a direction to increase the contact pressure such that the contact pressure decreases in the areas next to the nose and the contact pressure increases in the area of the chin.

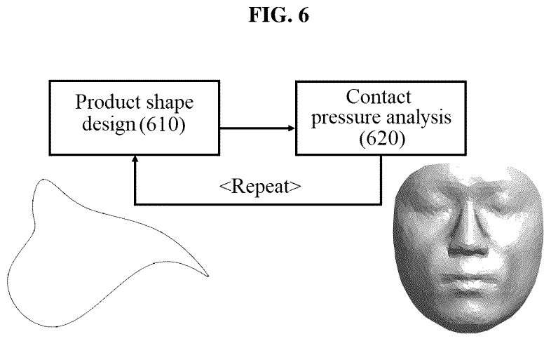

The product, of which the product shape has been changed through the process as described above, may be iteratively changed such that the contact pressures at all areas of the product shape are within the preset reference contact pressure range by repeatedly performing step S130 and step S140. For example, as shown in FIG. 6, the product shape is changed (design a form) by changing the shape of the product through contact pressure calculation, that is, by adjusting a changeable design point in the product shape (610), the contact pressure on the virtual face is recalculated for the changed product shape (virtual fit testing, 620) by allowing the changed product shape to be contacted again to the virtual subject, for example, a virtual face, and a process of again changing or designing the product shape using the recalculated contact pressure is again performed (630). It is possible to design an optimal product shape by repeatedly performing the above-described process until the contact pressure is within the reference contact pressure range for the virtual subject.

In the method of the present disclosure, the reference pressure range refers to a contact pressure with an appropriate amount of pressure, where the appropriate amount of pressure is neither too much nor too little. Since too much pressure may cause discomfort and pain, and too little pressure worn on the human body, such as in the case of oxygen masks and diving masks, may cause problems such as leakage, etc, the reference pressure range may be set, and the reference pressure range may be set by a business operator or individual providing the technology of the present disclosure, and vary according to the product.

When designing a product shape that fits multiple people in designing the product shape, the product shape may be designed in a way to minimize the distribution of pressure on the shapes of multiple people, and step S140 may present the optimal product shape to a designer designing the product shape using the contact pressure and the product shape in changing or designing the product shape and provide guidance regarding parts that need to be changed in the product shape. In this case, step S140 may provide a range of physical properties for the product, or the product may be designed in multiple sizes, such as small, medium, and large, depending on the range of properties that the product is able to accommodate. In this way, the method of the present disclosure may provide a design method that automatically finds the optimal product shape that best fits the human body by analyzing the contact pressure using finite element analysis, and also provide or recommend design guidance to the designer by finding a design solution through the algorithm of the present disclosure without the designer having to try different designs by hand.

As such, the method according to an embodiment of the present disclosure may design a product shape that provides an appropriate amount of pressure to the human body by analyzing the contact pressure between the subject and the product using finite element analysis, and may be applied to a variety of products worn on various parts of the human body, such as masks (oxygen masks, medical masks, customized masks for athletes), helmets, goggles, VR headsets, shoes, gloves, knee pads, ankle braces, and lumbar braces.

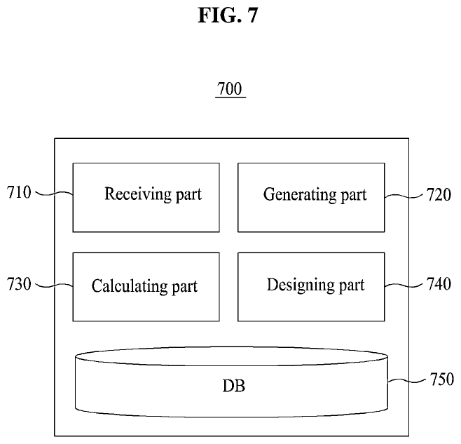

FIG. 7 illustrates a configuration for a product shape design device according to one embodiment of the present disclosure.

Referring to FIG. 7, a product shape design device 700 according to an embodiment of the present disclosure includes a receiving part 710, a generating part 720, a calculating part 730, a designing part 740, and a database (DB) 750.

The DB 750 is a means of storing all kinds of data related to the present disclosure, which may include preset template models, algorithms of the present disclosure, three-dimensional scan images of a subject, product shape information, and the like. Of course, the DB may include any data available in the present disclosure, in addition to the data described above.

The receiving part 710 receives human body scan data for a subject, such as a face.

In this case, the receiving part 710 may receive a mesh-shaped three-dimensional scan image of the subject, or a general three-dimensional scan image that is not mesh-shaped, and the three-dimensional scan data received may be for a single person or for multiple people.

The generating part 720 generates a virtual subject corresponding to the subject based on the received human body scan data.

In this case, the generating part 720 may generate a virtual subject corresponding to the subject based on the mesh structure consistency between a pre-registered template mesh model and a scanned three-dimensional mesh image of the subject. The mesh shape of the template model may have a difference in number of meshes and mesh size between a region in contact with the product and a region not in contact with the product, and the mesh size of the region in contact may be smaller than the mesh size of the region not in contact and the number of meshes in the region in contact may be larger than the number of meshes in the area not in contact.

The calculating part 730 may contact the virtual subject and the preconfigured product shape to be designed, and calculate a contact pressure in an area where the virtual object and the product shape are in contact with each other.

In this case, the calculating part 730 may calculate a pressure of contact where the virtual subject and the product shape are in contact with each other, and calculate the contact pressure based on a change in each mesh of the virtual object and a displacement vector of the vertices of the each mesh due to the contact between the product shape and the virtual subject.

The designing part 740 designs a product shape by changing the product shape based on the calculated contact pressure.

In this case, the designing part 740 may recalculate the contact pressure between the changed product shape and the virtual subject after changing the product shape, determine the changed product shape as a final product shape when the recalculated contact pressure is within a preset reference pressure range, and again change the product shape again based on the recalculated contact pressure when the recalculated contact pressure is outside the reference pressure range.

Further, the designing part 740 may design the product shape by changing the product shape based on the contact pressure for an area where the calculated contact pressure is outside the reference pressure range among areas of the product shape.

Although the description is omitted with reference to the apparatus of FIG. 7, components constituting FIG. 7 may include all the contents described with reference to FIGS. 1 to 6, which are obvious to those skilled in the art.

The apparatus described herein may be implemented with hardware components and software components and/or a combination of the hardware components and the software components. For example, the apparatus and components described in the embodiments may be implemented using one or more general-purpose or special purpose computers, such as, for example, a processor, a controller, an arithmetic logic unit (ALU), a digital signal processor, a microcomputer, a field programmable array (FPGA), a programmable logic unit (PLU), a microprocessor or any other device capable of executing and responding to instructions. The processing device may run an operating system (OS) and one or more software applications that run on the OS. The processing device also may access, store, manipulate, process, and create data in response to execution of the software. For convenience of understanding, one processing device is described as being used, but those skilled in the art will appreciate that the processing device includes a plurality of processing elements and/or multiple types of processing elements. For example, the processing device may include multiple processors or a single processor and a single controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described methods may be embodied in the form of program instructions that can be executed by various computer means and recorded on a computer-readable medium. The computer readable medium may include program instructions, data files, data structures, and the like, alone or in combination. Program instructions recorded on the media may be those specially designed and constructed for the purposes of the inventive concept, or they may be of the kind well-known and available to those having skill in the computer software arts. Examples of computer readable recording media include magnetic media such as hard disks, floppy disks and magnetic tape, optical media such as CD-ROMs, DVDs, and magnetic disks such as floppy disks, Magneto-optical media, and hardware devices specifically configured to store and execute program instructions, such as ROM, RAM, flash memory, and the like. Examples of program instructions include not only machine code generated by a compiler, but also high-level language code that can be executed by a computer using an interpreter or the like.

### MODE FOR INVENTION

Although the embodiments have been described by the limited embodiments and the drawings as described above, various modifications and variations are possible to those skilled in the art from the above description. For example, the described techniques may be performed in a different order than the described method, and/or components of the described systems, structures, devices, circuits, etc. may be combined or combined in a different form than the described method, or other components, or even when replaced or substituted by equivalents, an appropriate result can be achieved.

Therefore, other implementations, other embodiments, and equivalents to the claims are within the scope of the following claims.

1. A product shape design method comprising:
receiving body scan data of a subject;
generating a virtual subject corresponding to the subject on the basis of the received body scan data;
contacting the generated virtual subject with a preconfigured product shape to be designed and calculating contact pressure generated by contact of the virtual subject and the product shape; and
designing the product shape by changing the product shape on the basis of the calculated contact pressure.

2. The product shape design method of claim 1, wherein the calculating of the contact pressure includes calculating a pressure of contact where the virtual subject is in contact with and the product shape using finite element analysis.

3. The product shape design method of claim 1, wherein the receiving of the body scan data includes receiving a scanned three-dimensional mesh image for the subject.

4. The product shape design method of claim 3, wherein the generating of the virtual subject includes generating the virtual subject based on mesh structure consistency between a pre-registered template mesh model and a scanned three-dimensional mesh image of the subject.

5. The product shape design method of claim 1, wherein the designing of the product shape includes recalculating the contact pressure between the designed product shape and the virtual subject, determining the designed product shape as a final product shape when the recalculated contact pressure is within a preset reference pressure range, and changing the designed product shape based on the recalculated contact pressure when the recalculated contact pressure is outside the preset reference pressure range.

6. The product shape design method of claim 1, wherein the designing of the product shape includes designing the product shape by changing an area where the calculated contact pressure is outside a preset reference pressure range among areas of the product shape based on the contact pressure of the area where the calculated contact pressure is outside the preset reference pressure range.

7. The product shape design method of claim 1, wherein the calculating of the contact pressure includes calculating a contact pressure based on a change in each mesh of the virtual subject due to contact between the product shape and the virtual subject and a displacement vector of vertices of the each mesh.

8. A product shape design device comprising:
a receiving part configured to receive body scan data of a subject;
a generating part configured to generate a virtual subject corresponding to the subject based on the received human body scan data;
a calculating part configured to contact the generated virtual subject with a preconfigured product shape to be designed and calculate contact pressure generated by contact of the virtual subject and the product shape; and
a designing part configured to design the product shape by changing the product shape on the basis of the calculated contact pressure.

9. The product shape design device of claim 8, wherein the calculating part is configured to calculate a pressure of contact where the virtual subject is in contact with and the product shape using finite element analysis.

10. The product shape design device of claim 8, wherein the receiving part is configured to receive a scanned three-dimensional mesh image for the subject.

11. The product shape design device of claim 10, wherein wherein the generating part is configured to generate the virtual subject based on mesh structure consistency between a pre-registered template mesh model and a scanned three-dimensional mesh image of the subject.

12. The product shape design device of claim 8, wherein the designing part is configured to recalculate the contact pressure between the designed product shape and the virtual subject, determine the designed product shape as a final product shape when the recalculated contact pressure is within a preset reference pressure range, and change the designed product shape based on the recalculated contact pressure when the recalculated contact pressure is outside the preset reference pressure range.

13. The product shape design device of claim 8, wherein the designing part is configured to design the product shape by changing an area where the calculated contact pressure is outside a preset reference pressure range among areas of the product shape based on the contact pressure of the area where the calculated contact pressure is outside the preset reference pressure range.

14. The product shape design device of claim 8, wherein the calculating part is configured to calculate a contact pressure based on a change in each mesh of the virtual subject due to contact between the product shape and the virtual subject and a displacement vector of vertices of the each mesh.
